(19) United States
(12) Patent Application Publication
(10) Pub. No.: US 2026/0171042 A1
(43) Pub. Date: Jun. 18, 2026

(54) DISPLAY DEVICE

(71) Applicant: Japan Display Inc., Tokyo (JP)

(72) Inventors: Tadayoshi KATSUTA, Tokyo (JP); Gen KOIDE, Tokyo (JP)

(21) Appl. No.: 19/388,058

(22) Filed: Nov. 13, 2025

(30) Foreign Application Priority Data
Dec. 18, 2024 (JP) 2024-221322

(51) Int. Cl. G09G 3/36; G09G 3/34

(52) U.S. Cl. CPC G09G 3/3677; G09G 3/3413; G09G 3/3688; G09G 2300/0426; G09G 2300/0452; G09G 2300/0465; G09G 2310/0286; G09G 2310/08

(57) ABSTRACT

To provide a technique capable of achieving both high definition and the large number of pixels in a display device. A display device includes: a plurality of pixels arranged in a matrix shape; a plurality of gate lines connected to the pixels arranged in a row direction; a plurality of signal lines connected to the pixels arranged in a column direction; a gate line driving circuit for scanning the plurality of gate lines; and a signal line driving circuit for supplying gradation signals to the plurality of signal lines. The pixels arranged in the column direction include a plurality of first pixels connected to a first signal line and a plurality of second pixels connected to a second signal line. The first signal line and the second signal line are provided in parallel with the pixels arranged in the column direction.

### CLAIM OF PRIORITY

The present application claims priority from Japanese Patent Application JP 2024-221322 filed on December 18, 2024, the contents of which is hereby incorporated by reference into this application.

### BACKGROUND OF THE INVENTION

### (1) Field of the Invention

The present disclosure relates to a display device.

### (2) Description of the Related Art

A display device capable of reducing the number of video lines is proposed in, for example, JP-2010-97067-A.

### SUMMARY OF THE INVENTION

In JP-2010-97067-A, a scanning line is assigned to each color, but a method of generating a driving signal of the scanning line is not disclosed.

The disclosing party has devised the present disclosure in the process of considering a technique capable of achieving both high definition and the large number of pixels in a display device.

The present disclosure provides a technique capable of achieving both high definition and the large number of pixels in a display device.

Other problems and new features will become apparent from the description of the present specification and the accompanying drawings.

The following description is the summary of an outline of representative examples of the present invention.

That is, according to an aspect of the present invention, provided is a display device including: a plurality of pixels arranged in a matrix shape; a plurality of gate lines connected to the pixels arranged in a row direction; a plurality of signal lines connected to the pixels arranged in a column direction; a gate line driving circuit for scanning the plurality of gate lines; and a signal line driving circuit for supplying gradation signals to the plurality of signal lines, in which the pixels arranged in the column direction include a plurality of first pixels connected to a first signal line and a plurality of second pixels connected to a second signal line, and wherein the first signal line and the second signal line are provided in parallel with the pixels arranged in the column direction.

In addition, according to another aspect of the present invention, provided is a display device including: a plurality of pixels arranged in a matrix shape; a plurality of gate lines connected to the pixels arranged in a row direction; a plurality of signal lines connected to the pixels arranged in a column direction; a gate line driving circuit for scanning the plurality of gate lines; and a signal line driving circuit for supplying gradation signals to the plurality of signal lines, in which the gate line driving circuit includes a first selection signal for selecting one of two adjacent gate lines and a second selection signal for selecting other one of the two adjacent gate lines.

### BRIEF DESCRIPTION OF THE DRAWINGS

FIG. 1 is a diagram for depicting a configuration example of a display device according to a comparative example;

FIG. 2 is a diagram for depicting a timing example of the display device in FIG. 1;

FIG. 3 is a diagram for explaining parasitic elements between a source terminal and a signal line of the display device in FIG. 1;

FIG. 4 is a diagram for depicting a configuration example of a display device according to a first embodiment;

FIG. 5 is a diagram for depicting a timing example of the display device in FIG. 4;

FIG. 6 is a diagram for explaining parasitic elements between a source terminal and a signal line of the display device in FIG. 4;

FIG. 7 is a diagram for depicting a configuration example of a display device according to a modified example;

FIG. 8 is a diagram for depicting a configuration example of a display device according to a second embodiment;

FIG. 9 is a diagram for depicting a timing example of the display device in FIG. 8;

FIG. 10 is a diagram for explaining parasitic elements between a source terminal and a signal line of the display device in FIG. 8;

FIG. 11 is a diagram for depicting a configuration example of a gate driver selection circuit and a gate driving circuit;

FIG. 12 is a diagram for explaining a timing example of the gate driver selection circuit and the gate driving circuit;

FIG. 13 is a diagram for explaining a state where a display device (10a or 10b) has a flexible printed circuit board (FPC);

FIG. 14 is a diagram for explaining a state where a display device (10c) has the flexible printed circuit board (FPC); and

FIG. 15 is a diagram for depicting a configuration example of intersection portions between selection signal wiring MUXL and common potential wiring COML in FIG. 14.

### DETAILED DESCRIPTION OF THE PREFERRED EMBODIMENTS

Hereinafter, each embodiment of the present invention will be described with reference to the drawings.

It should be noted that the disclosure is merely an example, and appropriate changes that a person skilled in the art can easily arrive at while maintaining the gist of the invention are naturally included in the scope of the present invention. In addition, in order to make the description clearer, the drawings schematically depict the width, thickness, shape, and the like of each section in some cases in comparison with the actual mode, but they are merely examples and do not limit the interpretation of the present invention.

In addition, in the present specification and each drawing, elements similar to those already described with reference to previously-presented drawings are denoted by the same reference numerals, and detailed description thereof will be appropriately omitted in some cases.

The present embodiments disclose a liquid crystal display device as an example of a display device. For example, the liquid crystal display device can be used in various devices such as an augmented reality / virtual reality / mixed reality (AR/VR/MR) terminal, a smartphone, a tablet terminal, a mobile phone terminal, a personal computer, a television receiver, an in-vehicle device, goggles, and a game apparatus.

The “display device” refers to a general display device that displays a video by using a display panel. The “display panel” refers to a structure that displays a video by using an electro-optical layer. For example, the term “display panel” refers to a display cell including an electro-optical layer in some cases, or refers to a structure in some cases in which another optical member (a polarizing member, a backlight, a touch panel, or the like) or a semiconductor device provided with a driving circuit such as a source driver integrated circuit (IC) is mounted to a display cell. Here, the “electro-optical layer” may include a liquid crystal layer, an electrochromic (EC) layer, and the like as long as no technical contradiction occurs. Therefore, in the embodiments to be described later, a liquid crystal panel including a liquid crystal layer will be exemplified and described as a display panel, but application to display panels including other electro-optical layers described above is not excluded.

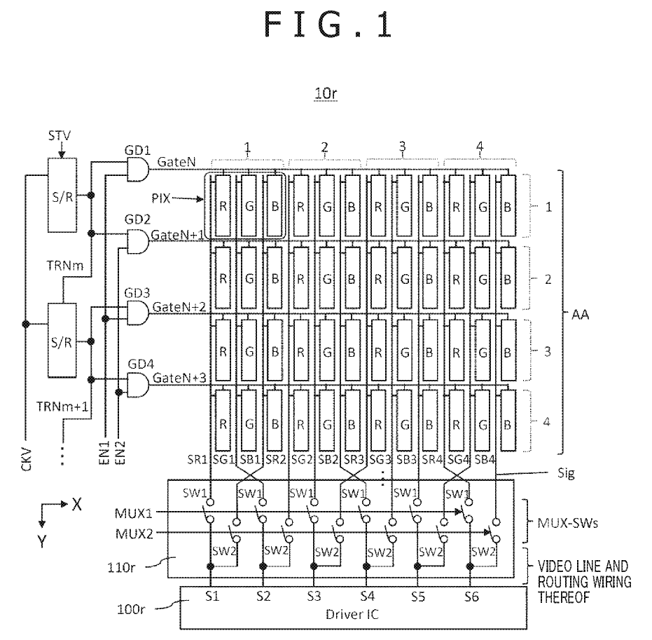

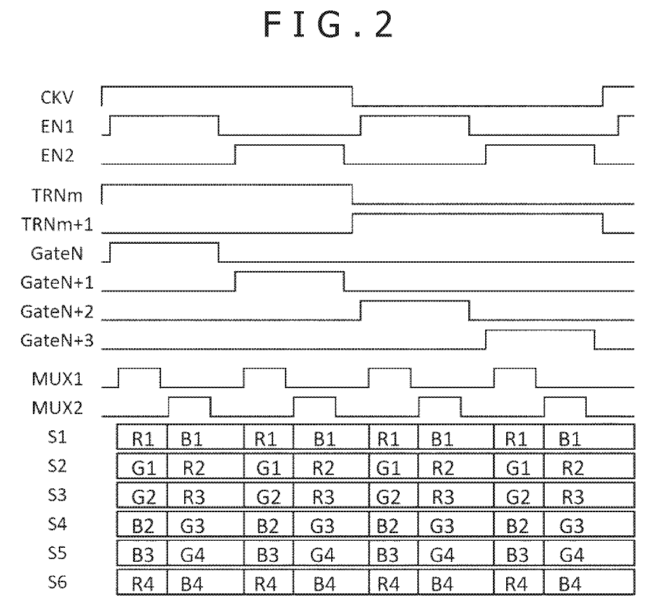

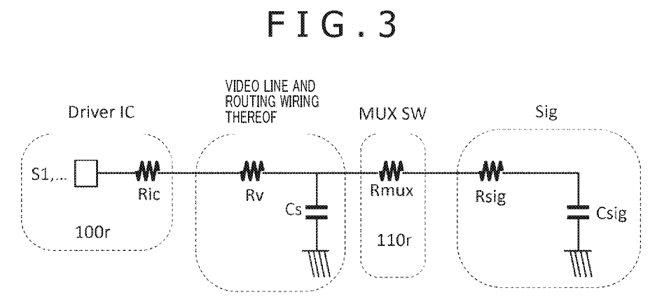

First, a display device according to a comparative example will be described by using the drawings. FIG. 1 is a diagram for depicting a configuration example of a display device according to the comparative example. FIG. 2 is a diagram for depicting a timing example of the display device in FIG. 1. FIG. 3 is a diagram for explaining parasitic elements between a source terminal and a signal line of the display device in FIG. 1.

As depicted in FIG. 1, a display device 10r has an active region (active region / display region) AA in which a plurality of gate lines, a plurality of signal lines, and a plurality of pixels are provided, and a plurality of pixels PIX arranged in a matrix shape are formed in the active region AA along a first direction X and a second direction Y intersecting the first direction X. Each pixel PIX includes one red pixel R, one blue pixel B, and one green pixel G as sub pixels. In this example, a plurality of pixels PIX arranged in a matrix shape of four rows and four columns, that is, a total of 16 pixels having four pixels in the first direction X (the horizontal direction and the row direction) and four pixels in the second direction Y (the vertical direction and the column direction) intersecting the first direction X are depicted as a representative example.

A plurality of gate lines (GateN, GateN+1, GateN+2, and GateN+3) are arranged so as to extend along the first direction X and to be juxtaposed in the second direction Y. Four pixels of the first row are connected to the gate line GateN. Four pixels of the second row are connected to the gate line GateN+1. Four pixels of the third row are connected to the gate line GateN+2. Four pixels of the fourth row are connected to the gate line GateN+3.

A plurality of gate drivers GD1 to GD4 are provided to drive the plurality of gate lines (GateN, GateN+1, GateN+2, and GateN+3). The gate driver GD1 drives the gate line GateN, and the gate driver GD2 drives the gate line GateN+1. The gate driver GD3 drives the gate line GateN+2, and the gate driver GD4 drives the gate line GateN+3.

The gate drivers GD1 and GD3 are configured to receive a first enable signal EN1, and the gate drivers GD2 and GD4 are configured to receive a second enable signal EN2. The gate drivers GD1 and GD2 are configured to receive a first transfer signal TRNm, and the gate drivers GD3 and GD4 are configured to receive a second transfer signal TRNm+1.

The first transfer signal TRNm is generated by a first shift register S/R, and the second transfer signal TRNm+1 is generated by a second shift register S/R. The first shift register S/R is configured to receive a start pulse STV and a transfer clock CKV, and takes in the high-level start pulse STV in synchronization with the high-level transfer clock CKV to generate the high-level first transfer signal TRNm. The second shift register S/R is configured to receive the first transfer signal TRNm and the transfer clock CKV, and takes in the high-level first transfer signal TRNm in synchronization with the low-level transfer clock CKV to generate the high-level second transfer signal TRNm+1. That is, the first shift register S/R and the second shift register S/R are configured to sequentially shift the high-level transfer signal in synchronization with the transfer clock CKV.

The gate driver GD1 supplies a high-level driving signal to the gate line GateN on the basis of the high-level first transfer signal TRNm and the high-level first enable signal EN1. The gate driver GD2 supplies a high-level driving signal to the gate line GateN+1 on the basis of the high-level first transfer signal TRNm and the high-level second enable signal EN2. The gate driver GD3 supplies a high-level driving signal to the gate line GateN+2 on the basis of the high-level second transfer signal TRNm+1 and the high-level first enable signal EN1. The gate driver GD4 supplies a high-level driving signal to the gate line GateN+3 on the basis of the high-level second transfer signal TRNm+1 and the high-level second enable signal EN2. In this way, the plurality of gate lines (GateN, GateN+1, GateN+2, and GateN+3) are scanned. The gate lines can be rephrased as scanning lines.

On the other hand, a plurality of signal lines Sig (SR1 to SR4, SG1 to SG4, and SB1 to SB4) include signal lines SR1 to SR4 for red pixels, signal lines SG1 to SG4 for green pixels, and signal lines SB1 to SB4 for blue pixels, which are provided so as to extend in the second direction Y.

The signal line SR1 is connected to each red pixel R of the four pixels in the first row. The signal line SG1 is connected to each green pixel G of the four pixels in the first row. The signal line SB1 is connected to each blue pixel B of the four pixels in the first row.

The signal line SR2 is connected to each red pixel R of the four pixels in the second row. The signal line SG2 is connected to each green pixel G of the four pixels in the second row. The signal line SB2 is connected to each blue pixel B of the four pixels in the second row.

The signal line SR3 is connected to each red pixel R of the four pixels in the third row. The signal line SG3 is connected to each green pixel G of the four pixels in the third row. The signal line SB3 is connected to each blue pixel B of the four pixels in the third row.

The signal line SR4 is connected to each red pixel R of the four pixels in the fourth row. The signal line SG4 is connected to each green pixel G of the four pixels in the fourth row. The signal line SB4 is connected to each blue pixel B of the four pixels in the fourth row.

A multiplexer 110r is provided between the plurality of signal lines Sig and a source line driver (Driver IC) 100r. The multiplexer 110r includes a plurality of first switches SW1 that are controlled to be on or off according to the level of a first selection signal MUX1, and a plurality of second switches SW2 that are controlled to be on or off according to the level of a second selection signal MUX2.

The source line driver 100r includes a plurality of source line terminals S1 to S6 for supplying signals to the plurality of signal lines Sig. The multiplexer 110r and the source line driver 100r can be rephrased as a signal line driving circuit that supplies gradation signals to the plurality of signal lines.

The first source line terminal S1 is connected to the signal line SR1 via the first switch SW1, and to the signal line SB1 via the second switch SW2. The second source line terminal S2 is connected to the signal line SG1 via the first switch SW1, and to the signal line SR2 via the second switch SW2. The third source line terminal S3 is connected to the signal line SG2 via the first switch SW1, and to the signal line SR3 via the second switch SW2.

The fourth source line terminal S4 is connected to the signal line SB2 via the first switch SW1, and to the signal line SG3 via the second switch SW2. The fifth source line terminal S5 is connected to the signal line SB3 via the first switch SW1, and to the signal line SG4 via the second switch SW2. The sixth source line terminal S6 is connected to the signal line SR4 via the first switch SW1, and to the signal line SB4 via the second switch SW2.

Next, an example of timing will be described by using FIG. 2. Since the transfer clock CKV, the first transfer signal TRNm, the second transfer signal TRNm+1, the first enable signal EN1, and the second enable signal EN2 have been described, the gate lines GateN, GateN+1, GateN+2, and GateN+3, the first selection signal MUX1, the second selection signal MUX2, and the plurality of source line terminals S1 to S6 will be described below.

When the gate line GateN is set to the high level and the first selection signal MUX1 is set to the high level, gradation signals of a red signal R1, a green signal G1, a green signal G2, a blue signal B2, a blue signal B3, and a red signal R4 are supplied from the source line terminals S1 to S6 to the signal lines SR1, SG1, SG2, SB2, SB3, and SR4, respectively, and the corresponding gradation signals are written to the red pixel R, the green pixel G, the green pixel G, the blue pixel B, the blue pixel B, and the red pixel R of the corresponding pixels in the four pixels of the corresponding first row.

When the gate line GateN is set to the high level and the second selection signal MUX2 is set to the high level, gradation signals of a blue signal B1, a red signal R2, a red signal R3, a green signal G3, a green signal G4, and a blue signal B4 are supplied from the source line terminals S1 to S6 to the signal lines SB1, SR2, SR3, SG3, SG4, and SB4, respectively, and the corresponding gradation signals are written to the blue pixel B, the red pixel R, the red pixel R, the green pixel G, the green pixel G, and the blue pixel B of the corresponding pixels in the four pixels of the corresponding first row.

When the gate line GateN+1 is set to the high level and the first selection signal MUX1 is set to the high level, gradation signals of the red signal R1, the green signal G1, the green signal G2, the blue signal B2, the blue signal B3, and the red signal R4 are supplied from the source line terminals S1 to S6 to the signal lines SR1, SG1, SG2, SB2, SB3, and SR4, respectively, and the corresponding gradation signals are written to the red pixel R, the green pixel G, the green pixel G, the blue pixel B, the blue pixel B, and the red pixel R of the corresponding pixels in the four pixels of the corresponding second row.

When the gate line GateN+1 is set to the high level and the second selection signal MUX2 is set to the high level, gradation signals of the blue signal B1, the red signal R2, the red signal R3, the green signal G3, the green signal G4, and the blue signal B4 are supplied from the source line terminals S1 to S6 to the signal lines SB1, SR2, SR3, SG3, SG4, and SB4, respectively, and the corresponding gradation signals are written to the blue pixel B, the red pixel R, the red pixel R, the green pixel G, the green pixel G, and the blue pixel B of the corresponding pixels in the four pixels of the corresponding second row.

When the gate line GateN+2 is set to the high level and the first selection signal MUX1 is set to the high level, gradation signals of the red signal R1, the green signal G1, the green signal G2, the blue signal B2, the blue signal B3, and the red signal R4 are supplied from the source line terminals S1 to S6 to the signal lines SR1, SG1, SG2, SB2, SB3, and SR4, respectively, and the corresponding gradation signals are written to the red pixel R, the green pixel G, the green pixel G, the blue pixel B, the blue pixel B, and the red pixel R of the corresponding pixels in the four pixels of the corresponding third row.

When the gate line GateN+2 is set to the high level and the second selection signal MUX2 is set to the high level, gradation signals of the blue signal B1, the red signal R2, the red signal R3, the green signal G3, the green signal G4, and the blue signal B4 are supplied from the source line terminals S1 to S6 to the signal lines SB1, SR2, SR3, SG3, SG4, and SB4, respectively, and the corresponding gradation signals are written to the blue pixel B, the red pixel R, the red pixel R, the green pixel G, the green pixel G, and the blue pixel B of the corresponding pixels in the four pixels of the corresponding third row.

When the gate line GateN+3 is set to the high level and the first selection signal MUX1 is set to the high level, gradation signals of the red signal R1, the green signal G1, the green signal G2, the blue signal B2, the blue signal B3, and the red signal R4 are supplied from the source line terminals S1 to S6 to the signal lines SR1, SG1, SG2, SB2, SB3, and SR4, respectively, and the corresponding gradation signals are written to the red pixel R, the green pixel G, the green pixel G, the blue pixel B, the blue pixel B, and the red pixel R of the corresponding pixels in the four pixels of the corresponding fourth row.

When the gate line GateN+3 is set to the high level and the second selection signal MUX2 is set to the high level, gradation signals of the blue signal B1, the red signal R2, the red signal R3, the green signal G3, the green signal G4, and the blue signal B4 are supplied from the source line terminals S1 to S6 to the signal lines SB1, SR2, SR3, SG3, SG4, and SB4, respectively, and the corresponding gradation signals are written to the blue pixel B, the red pixel R, the red pixel R, the green pixel G, the green pixel G, and the blue pixel B of the corresponding pixels in the four pixels of the corresponding fourth row.

Next, parasitic elements between the source terminals and the signal lines of the display device will be described by using FIG. 3. FIG. 3 depicts a parasitic resistance element and a parasitic capacitive element as parasitic elements between the source terminals (S1 and the like) and the signal lines (Sig: SR1 to SR4, SG1 to SG4, and SB1 to SB4). As depicted in FIG. 3, the following parasitic elements exist between the source terminal S1 and the signal line Sig.

1) A parasitic resistance element Ric of wiring connected to the source terminal S1 in the source line driver 100r

2) A parasitic resistance element Rv and a parasitic capacitive element Cs based on a video line and routing wiring thereof between the wiring connected to the source terminal S1 and the first switch SW1 and the second switch SW2 in the multiplexer 110r

3) An internal parasitic resistance element Rmux of the first switch SW1 and the second switch SW2 in the multiplexer 110r

4) A parasitic resistance element Rsig and a parasitic capacitive element Csig of the signal line Sig

Thus, the following problems are conceivable in the display device 10r according to the comparative example of FIG. 1.

(1) It is difficult to realize high resolution and improvement in the number of pixels (namely, maintaining the number of inches).

(2) As the aperture ratio lowers, the optical characteristics deteriorate.

(3) There is no source line driver that can adapt to significant improvement in the number of pixels or the number of source line drivers is small.

(4) As the time constant between the video line and the signal line Sig increases, it becomes difficult to complete writing of a signal to each pixel within a specified time.

### First embodiment

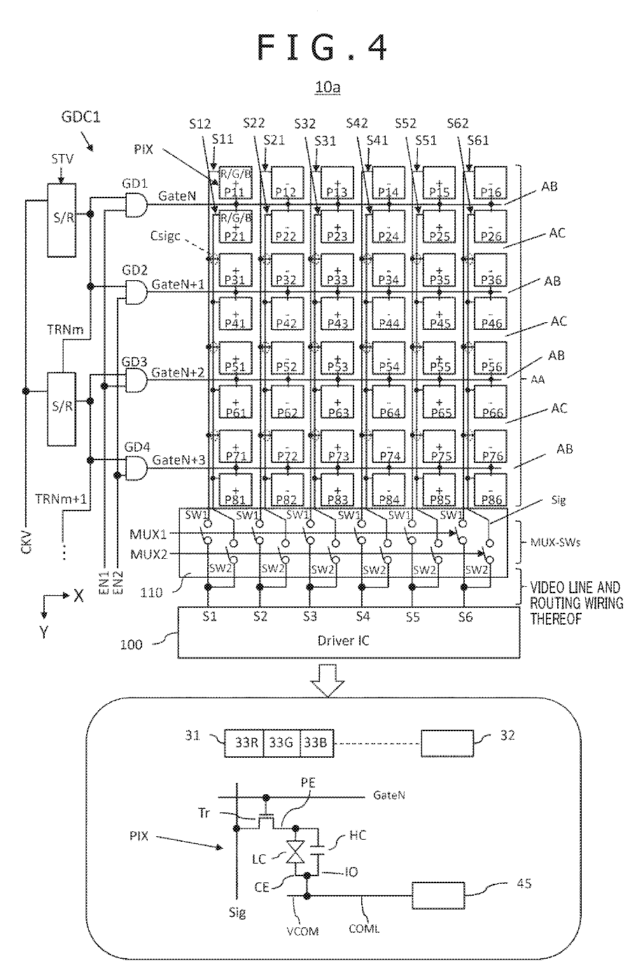

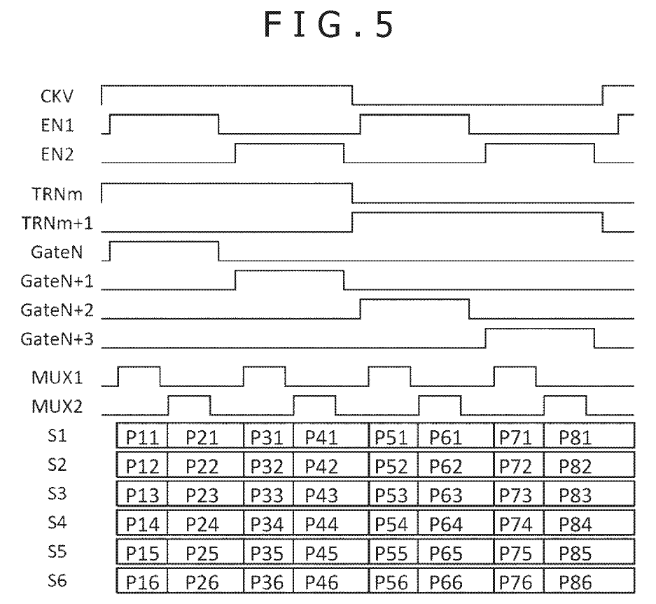

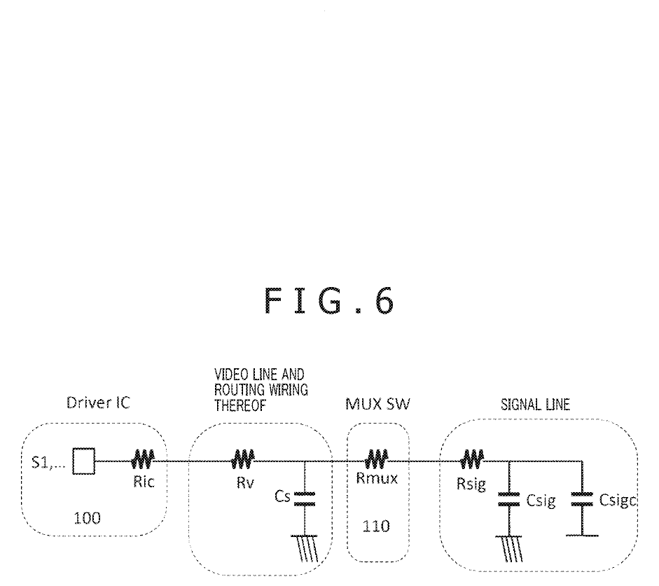

Field sequential driving has been known as a method for improving a decrease in the aperture ratio accompanying high definition. If the number of pixels in the vertical direction and the number of pixels in the horizontal direction are to be increased while employing the field sequential driving, a display device 10a having a connection configuration of signal lines and gate lines as depicted in FIG. 4 is conceivable. Hereinafter, the display device 10a according to a first embodiment will be described by using the drawings. FIG. 4 is a diagram for depicting a configuration example of a display device according to the first embodiment. FIG. 5 is a diagram for depicting a timing example of the display device in FIG. 4. FIG. 6 is a diagram for explaining parasitic elements between a source terminal and a signal line of the display device in FIG. 4.

As depicted in FIG. 4, the display device 10a has an active region AA, and a plurality of pixels PIX arranged in a matrix shape are formed in the active region AA along a first direction X and a second direction Y intersecting the first direction X. Each pixel PIX is driven by a driving method in which one frame period has a plurality of sub-frame (field) periods. Such a driving method is called, for example, a field sequential method. In the field sequential method, red (R), green (G), and blue (B) images are selectively displayed for each sub-frame period. An image of each color displayed in time division is visually recognized by the user as a multicolor display image. While the display device 10r described with reference to FIG. 1 is of a color filter method and one pixel is formed by sub-pixels obtained by dividing the pixels PIX for each of a first color (red), a second color (green), and a third color (blue), such sub-pixel division is not necessary in the field sequential method. Accordingly, the number of pixels can be improved.

In this example, a plurality of pixels PIX arranged in a matrix shape of eight rows and six columns, that is, a total of 48 pixels having six pixels in the first direction X (the horizontal direction and the row direction) and eight pixels in the second direction Y (the vertical direction and the column direction) are depicted as a representative example.

Here, a representative configuration example of the pixels PIX and the field sequential method will be described. As depicted in an enlarged view in FIG. 4, a thin film transistor is used as a switching element Tr provided in each pixel PIX. As an example of the thin film transistor, a bottom gate type transistor or a top gate type transistor may be used. As the switching element Tr, a single gate thin film transistor is exemplified, but a double gate transistor may be used. One of the source electrode and the drain electrode of the switching element Tr is connected to a signal line (Sig), the gate electrode is connected to a gate line (GateN) that is a scanning line, and the other of the source electrode and the drain electrode is connected to one end of a capacitor of a polymer dispersed type liquid crystal LC. One end of the capacitor of the polymer dispersed type liquid crystal LC is connected to the switching element Tr via a pixel electrode PE, and the other end is connected to common potential wiring COML via a common electrode CE. In addition, a storage capacitor HC is generated between the pixel electrode PE and a storage capacitor electrode IO electrically connected to the common potential wiring COML. It should be noted that a common voltage VCOM is supplied to the common potential wiring COML from a common potential driving circuit 45.

A light emitting section 31 used in the field sequential method includes a light emitting body 33R of a first color (for example, red), a light emitting body 33G of a second color (for example, green), and a light emitting body 33B of a third color (for example, blue). A light source control section 32 controls the light emitting body 33R of the first color, the light emitting body 33G of the second color, and the light emitting body 33B of the third color to emit light in time division on the basis of a light source control signal. As described above, the light emitting body 33R of the first color, the light emitting body 33G of the second color, and the light emitting body 33B of the third color are driven in the field sequential method.

In addition, the plurality of pixels PIX are of a column inversion method in this example. In this example, the six pixels of one line (one row) in the first direction X represent bit inversion driving in which a voltage (a voltage written to the pixel PIX) applied to the liquid crystal layer is inverted between the positive polarity (+) and the negative polarity (-) for each pixel PIX. The polarities of the pixels are the same between the lines (that is, a plurality of pixels in the column direction).

A plurality of gate lines (GateN, GateN+1, GateN+2, and GateN+3) are arranged so as to extend along the first direction X and to be juxtaposed in the second direction Y. The six pixels of the first row and the six pixels of the second row are connected to the gate line GateN. The six pixels of the third row and the six pixels of the fourth row are connected to the gate line GateN+1. The six pixels of the fifth row and the six pixels of the sixth row are connected to the gate line GateN+2. The six pixels of the seventh row and the six pixels of the eighth row are connected to the gate line GateN+3.

A plurality of gate drivers GD1 to GD4 are provided to drive the plurality of gate lines (GateN, GateN+1, GateN+2, and GateN+3). The gate driver GD1 drives the gate line GateN, and the gate driver GD2 drives the gate line GateN+1. The gate driver GD3 drives the gate line GateN+2, and the gate driver GD4 drives the gate line GateN+3. It should be noted that since the driving of the plurality of the gate drivers GD1 to GD4 is the same as that in the display device 10r in FIG. 1, duplicate description thereof will be omitted. Here, a first shift register S/R, a second shift register S/R, and the plurality of gate drivers GD1 to GD4 of the display device 10a can be rephrased as a first gate line driving circuit GDC1.

A plurality of signal lines Sig (S11, S21, S31, S41, S51, and S61, or S12, S22, S32, S42, S52, and S62) are provided so as to extend in the second direction Y. In this example, two signal lines (S11 and S12, S21 and S22, S31 and S32, S41 and S42, S51 and S52, and S61 and S62) are arranged side by side in parallel with each other. Each of the signal lines S11, S21, S31, S41, S51, and S61 is connected to each pixel of the first row, the third row, the fifth row, and the seventh row. Each of the signal lines S12, S22, S32, S42, S52, and S62 is connected to each pixel of the second row, the fourth row, the six row, and the eighth row.

A multiplexer 110 is provided between the plurality of signal lines Sig and a source line driver 100. The multiplexer 110 includes a plurality of first switches SW1 that are controlled to be on or off according to the level of a first selection signal MUX1, and a plurality of second switches SW2 that are controlled to be on or off according to the level of a second selection signal MUX2.

The source line driver (Driver IC) 100 includes a plurality of source line terminals S1 to S6 for supplying signals to the plurality of signal lines Sig. The multiplexer 110 and the source line driver (Driver IC) 100 can be rephrased as a signal line driving circuit for supplying gradation signals to the plurality of signal lines.

The first source line terminal S1 is connected to the signal line S11 via the first switch SW1, and to the signal line S12 via the second switch SW2. The second source line terminal S2 is connected to the signal line S21 via the first switch SW1, and to the signal line S22 via the second switch SW2. The third source line terminal S3 is connected to the signal line S31 via the first switch SW1, and to the signal line S32 via the second switch SW2. The fourth source line terminal S4 is connected to the signal line S41 via the first switch SW1, and to the signal line S42 via the second switch SW2. The fifth source line terminal S5 is connected to the signal line S51 via the first switch SW1, and to the signal line S52 via the second switch SW2. The sixth source line terminal S6 is connected to the signal line S61 via the first switch SW1, and to the signal line S62 via the second switch SW2.

Next, an example of timing will be described by using FIG. 5. Source signals supplied to the source line terminals S1 to S6 at each timing will be described.

When the gate line GateN is set to the high level and the first selection signal MUX1 is set to the high level, gradation signals P11, P12, P13, P14, P15, and P16 are supplied from the source line terminals S1 to S6 to the signal lines S11, S21, S31, S41, S51, and S61, respectively, and the corresponding gradation signals are written to the six pixels of the corresponding first row.

Next, when the gate line GateN is set to the high level and the second selection signal MUX2 is set to the high level, gradation signals P21, P22, P23, P24, P25, and P26 are supplied from the source line terminals S1 to S6 to the signal lines S12, S22, S32, S42, S52, and S62, respectively, and the corresponding gradation signals are written to the six pixels of the corresponding second row.

Next, when the gate line GateN+1 is set to the high level and the first selection signal MUX1 is set to the high level, gradation signals P31, P32, P33, P34, P35, and P36 are supplied from the source line terminals S1 to S6 to the signal lines S11, S21, S31, S41, S51, and S61, respectively, and the corresponding gradation signals are written to the six pixels of the corresponding third row.

Next, when the gate line GateN+1 is set to the high level and the second selection signal MUX2 is set to the high level, gradation signals P41, P42, P43, P44, P45, and P46 are supplied from the source line terminals S1 to S6 to the signal lines S12, S22, S32, S42, S52, and S62, respectively, and the corresponding gradation signals are written to the six pixels of the corresponding fourth row.

Next, when the gate line GateN+2 is set to the high level and the first selection signal MUX1 is set to the high level, gradation signals P51, P52, P53, P54, P55, and P56 are supplied from the source line terminals S1 to S6 to the signal lines S11, S21, S31, S41, S51, and S61, respectively, and the corresponding gradation signals are written to the six pixels of the corresponding fifth row.

Next, when the gate line GateN+2 is set to the high level and the second selection signal MUX2 is set to the high level, gradation signals P61, P62, P63, P64, P65, and P66 are supplied from the source line terminals S1 to S6 to the signal lines S12, S22, S32, S42, S52, and S62, respectively, and the corresponding gradation signals are written to the six pixels of the corresponding sixth row.

Next, when the gate line GateN+3 is set to the high level and the first selection signal MUX1 is set to the high level, gradation signals P71, P72, P73, P74, P75, and P76 are supplied from the source line terminals S1 to S6 to the signal lines S11, S21, S31, S41, S51, and S61, respectively, and the corresponding gradation signals are written to the six pixels of the corresponding seventh row.

Next, when the gate line GateN+3 is set to the high level and the second selection signal MUX2 is set to the high level, gradation signals P81, P82, P83, P84, P85, and P86 are supplied from the source line terminals S1 to S6 to the signal lines S12, S22, S32, S42, S52, and S62, respectively, and the corresponding gradation signals are written to the six pixels of the corresponding eighth row.

Next, parasitic elements between the source terminals and the signal lines of the display device will be described by using FIG. 6. FIG. 6 depicts a parasitic resistance element and a parasitic capacitive element as parasitic elements between the source terminals (S1 and the like) and the signal lines (Sig: S11, S21, S31, S41, S51, S61, S12, S22, S32, S42, S52, and S62). As depicted in FIG. 6, the following parasitic elements exist between the source terminal S1 and the signal line Sig.

1) A parasitic resistance element Ric of wiring connected to the source terminal S1 in the source line driver 100

2) A parasitic resistance element Rv and a parasitic capacitive element Cs based on a video line and routing wiring thereof between the wiring connected to the source terminal S1 and the first switch SW1 and the second switch SW2 in the multiplexer 110

3) An internal parasitic resistance element Rmux of the first switch SW1 and the second switch SW2 in the multiplexer 110

4) A parasitic resistance element Rsig and a parasitic capacitive element Csig of the signal line Sig and a cross capacity Csigc between two signal lines

That is, the cross capacity Csigc increases. In FIG. 4, the cross capacity Csigc occurs at portions (the third row, the fifth row, and the seventh row) indicated by round dotted lines.

Thus, the followings are conceivable in the display device 10a of FIG. 4.

(1) Although the aperture ratio and the optical characteristics are improved as compared with the display device 10r of FIG. 1, there is a loss of the aperture ratio because two signal lines are arranged in parallel. It should be noted that black matrix layers for shielding light are preferably provided above arrangement portions AB of the plurality of gate lines (GateN, GateN+1, GateN+2, and GateN+3) in FIG. 4. On the other hand, in consideration of the continuity of the pixels, black matrix layers for light are preferably provided in a region AC between the second row and the third row, a region AC between the fourth row and the fifth row, and a region AC between the sixth row and the seventh row, where no gate line is arranged.

(2) The number of pixels can be 1.5 times in the first direction X and twice in the second direction as compared with the display device 10r in FIG. 1.

(3) Since the time constant between the video line and the signal line Sig is not improved as compared with the display device 10r in FIG. 1, it becomes difficult to complete writing of a signal to each pixel within a specified time.

### Modified example

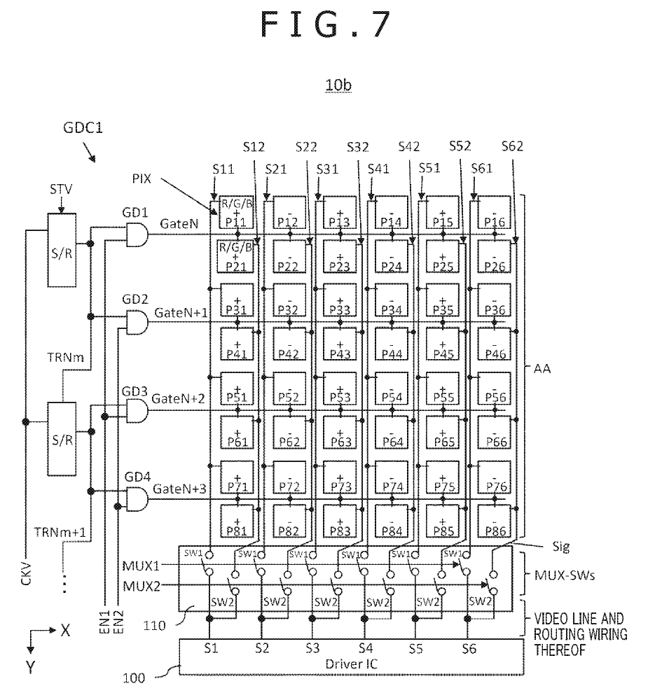

Next, a display device 10b according to a modified example of the first embodiment will be described by using FIG. 7. FIG. 7 is a diagram for depicting a configuration example of a display device according to the modified example. The display device 10b in FIG. 7 is different from the display device 10a in FIG. 4 in that two signal lines (S11 and S12, S21 and S22, S31 and S32, S41 and S42, S51 and S52, and S61 and S62) are arranged on the left and right sides of the pixels of the corresponding columns along the second direction Y and connected to the corresponding pixels. Accordingly, it is possible to reduce the cross capacity Csigc between two signal lines. Here, a first shift register S/R, a second shift register S/R, and a plurality of gate drivers GD1 to GD4 of the display device 10b can be rephrased as a first gate line driving circuit GDC1. Other configurations of the display device 10b in FIG. 7 are the same as those of the display device 10a in FIG. 4, and thus duplicate description thereof will be omitted.

The display devices 10a and 10b of the first embodiment can be summarized as follows.

The display devices 10a and 10b include: a plurality of pixels (PIX: P11 to P86) arranged in a matrix shape in a row direction (first direction X) and a column direction (second direction Y); a plurality of gate lines (GateN to GateN+3) connected to the pixels arranged in the row direction such that each pixel arranged in one row direction is connected to one gate line in the plurality of pixels PIX; a plurality of signal lines (S11 to S61 and S12 to S62) connected to the pixels arranged in the column direction in the plurality of pixels PIX; a gate line driving circuit GDC1 for scanning the plurality of gate lines (GateN to GateN+3); and signal line driving circuits (100 and 110) for supplying gradation signals to the plurality of signal lines (S11 to S61 and S12 to S62).

The pixels arranged in the column direction include a plurality of first pixels (P11 to P16, P31 to P36, P51 to P56, and P71 to P76) connected to first signal lines (S11 to S61) and a plurality of second pixels (P21 to P26, P41 to P46, P61 to P66, and P81 to P86) connected to second signal lines (S12 to S62).

The first signal lines (S11 to S61) and the second signal lines (S12 to S62) are provided in parallel with the pixels arranged in the column direction.

The plurality of first pixels (P11 to P16, P31 to P36, P51 to P56, and P71 to P76) and the plurality of second pixels (P21 to P26, P41 to P46, P61 to P66, and P81 to P86) are alternately arranged in the column direction.

In the display device 10a, the first signal lines (S11 to S61) and the second signal lines (S12 to S62) are arranged in parallel on one side of the pixels arranged in the column direction.

In the display device 10b, the first signal lines (S11 to S61) and the second signal lines (S12 to S62) are arranged in parallel so as to sandwich the pixels arranged in the column direction.

When the gate line driving circuit GDC1 selects one gate line, the signal line driving circuits (100 and 110) write the corresponding gradation signals from the first signal lines (S11 to S61) to the plurality of first pixels (P11 to P16, P31 to P36, P51 to P56, and P71 to P76), and then write the corresponding gradation signals from the second signal lines (S12 to S62) to the plurality of second pixels (P21 to P26, P41 to P46, P61 to P66, and P81 to P86).

### Second embodiment

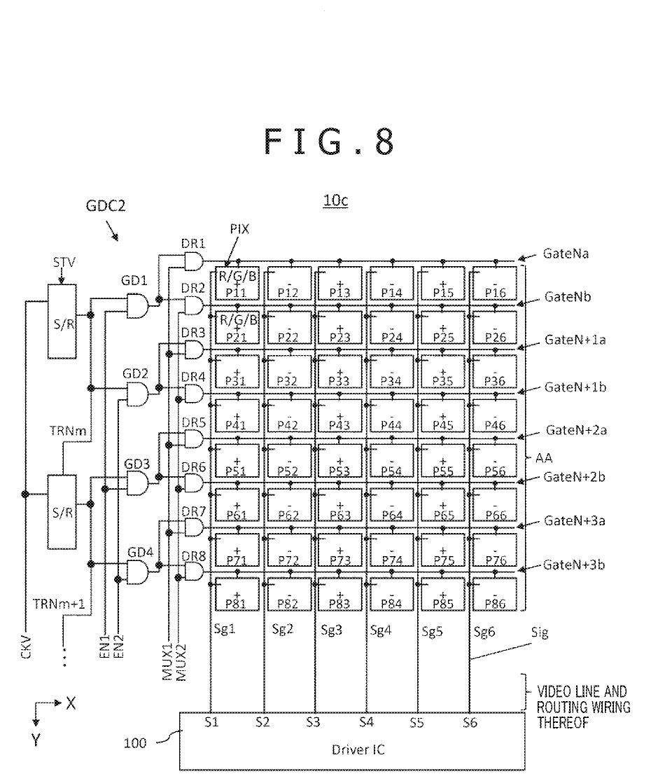

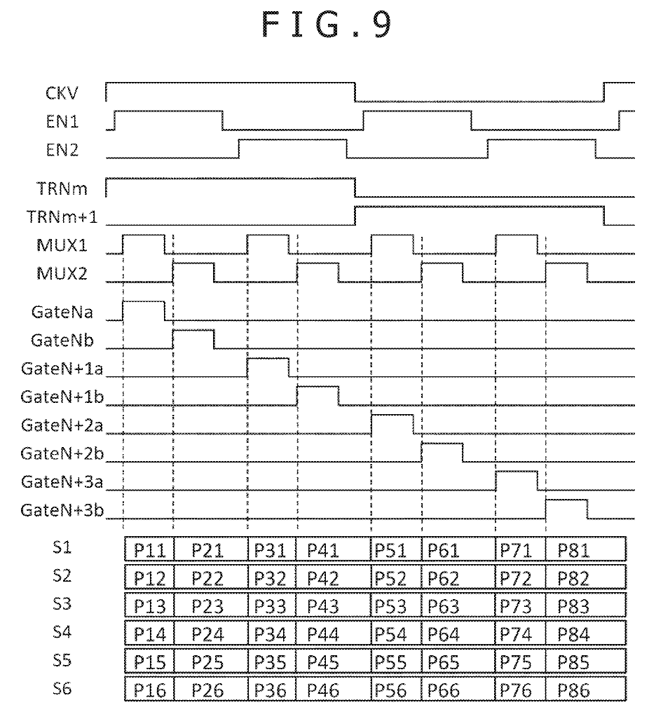

In a second embodiment, a configuration example of a display device 10c will be described in which the first selection signal MUX1 and the second selection signal MUX2 described in the first embodiment are assigned to generation of gate signals, the number of signal lines Sig is reduced, and the multiplexer between the signal lines Sig and the source line driver is eliminated. FIG. 8 is a diagram for depicting a configuration example of a display device according to the second embodiment. FIG. 9 is a diagram for depicting a timing example of the display device in FIG. 8. FIG. 10 is a diagram for explaining parasitic elements between a source terminal and a signal line of the display device in FIG. 8.

The display device 10c depicted in FIG. 8 has a configuration of the field sequential method as similar to the first embodiment. The display device 10c has an active region AA, and a plurality of pixels PIX arranged in a matrix shape are formed in the active region AA along a first direction X and a second direction Y intersecting the first direction X. Each pixel PIX is driven by a driving method in which one frame period has a plurality of sub-frame (field) periods.

In this example, the plurality of pixels PIX arranged in a matrix shape of eight rows and six columns, that is, a total of 48 pixels having six pixels in the first direction X (the horizontal direction and the row direction) and eight pixels in the second direction Y (the vertical direction and the column direction) are depicted as a representative example. A representative configuration example of the pixels PIX and the field sequential method has been described with reference to FIG. 4, and duplicate description thereof will be omitted.

A plurality of gate lines (GateNa, GateNb, GateN+1a, GateN+1b, GateN+2a, GateN+2b, GateN+3a, and GateN+3b) are arranged so as to extend along the first direction X and to be juxtaposed in the second direction Y.

Six pixels of the first row are connected to the gate line GateNa. Six pixels of the second row are connected to the gate line GateNb. Six pixels of the third row are connected to the gate line GateN+1a. Six pixels of the fourth row are connected to the gate line GateN+1b. Six pixels of the fifth row are connected to the gate line GateN+2a. Six pixels of the sixth row are connected to the gate line GateN+2b. Six pixels of the seventh row are connected to the gate line GateN+3a. Six pixels of the eighth row are connected to the gate line GateN+3b.

Gate driving circuits DR1 to DR8 in the final stage are provided to drive the plurality of gate lines (GateNa, GateNb, GateN+1a, GateN+1b, GateN+2a, GateN+2b, GateN+3a, and GateN+3b). The gate driving circuit DR1 drives the gate line GateNa, and the gate driving circuit DR2 drives the gate line GateNb. The gate driving circuit DR3 drives GateNa+1a, and the gate driving circuit DR4 drives GateN+1b. The gate driving circuit DR5 drives the gate line GateN+2a, and the gate driving circuit DR6 drives the gate line GateN+2b. The gate driving circuit DR7 drives the gate line GateN+3a, and the gate driving circuit DR8 drives the gate line GateN+3b.

The first selection signal MUX1 is supplied to second inputs of the gate driving circuits DR1, DR3, DR5, and DR7, and the second selection signal MUX2 is supplied to second inputs of the gate driving circuits DR2, DR4, DR6, and DR8. Here, the first selection signal MUX1 is set to a selection level (high level) when selecting one (GateNa, GateN+1a, GateN+2a, or GateN+3a) of two adjacent gate lines. The second selection signal MUX2 is set to a selection level (high level) when selecting the other (GateNb, GateN+1b, GateN+2b, or GateN+3b) of two adjacent gate lines. The two adjacent gate lines can be, for example, (GateNa and GateNb), (GateN+1a and GateN+1b), (GateN+2a and GateN+2b), and (GateN+3a and GateN+3b).

As the connection configuration of the circuits (the two shift registers S/R and the gate drivers GD1 to GD4) in the preceding stage of the gate driving circuits DR1 to DR8 in the final stage, and the respective control signals (STV, CKV, TRNm, TRNm+1, EN1, and EN2), a circuit configuration similar to that of the display device 10a of the first embodiment is provided. Duplicate description of a part of the circuit configuration similar to that of the display device 10a of the first embodiment will be omitted. The first shift register S/R, the second shift register S/R, the plurality of gate drivers GD1 to GD4, and the gate driving circuits DR1 to DR8 of the display device 10c can be rephrased as a second gate line driving circuit GDC2.

Here, outputs of the gate drivers GD1 to GD4 are configured to be connected to first inputs of the gate driving circuits DR1 to DR8 in the final stage. That is, the output of the gate driver GD1 is connected to the first inputs of the gate driving circuits DR1 and DR2. The output of the gate driver GD2 is connected to the first inputs of the gate driving circuits DR3 and DR4. The output of the gate driver GD3 is connected to the first inputs of the gate driving circuits DR5 and DR6. The output of the gate driver GD4 is connected to the first inputs of the gate driving circuits DR7 and DR8. The gate drivers GD1 to GD4 can be rephrased as gate driver selection circuits GD1 to GD4.

Signal lines Sig (Sg1 to Sg6) are arranged so as to extend along the second direction Y and to be juxtaposed in the first direction X. Eight pixels of the first column are connected to the first signal line Sg1. Eight pixels of the second column are connected to the second signal line Sg2. Eight pixels of the third column are connected to the third signal line Sg3. Eight pixels of the fourth column are connected to the fourth signal line Sg4. Eight pixels of the fifth column are connected to the fifth signal line Sg5. Eight pixels of the sixth column are connected to the sixth signal line Sg6.

A source line driver (Driver IC) 100 includes a plurality of source line terminals S1 to S6 for supplying signals to the plurality of signal lines Sig (Sg1 to Sg6). The source line terminal S1 is connected to the signal line Sg1. The source line terminal S2 is connected to the signal line Sg2. The source line terminal S3 is connected to the signal line Sg3. The source line terminal S4 is connected to the signal line Sg4. The source line terminal S5 is connected to the signal line Sg5. The source line terminal S6 is connected to the signal line Sg6. The source line driver (Driver IC) 100 can be rephrased as a signal line driving circuit for supplying gradation signals to the plurality of signal lines.

Next, timing of the display device 10c will be described by using FIG. 9. The transfer clock CKV, the first transfer signal TRNm, the second transfer signal TRNm+1, the first enable signal EN1, and the second enable signal EN2 are the same as in the first embodiment. Hereinafter, the gate lines (GateNa, GateNb, GateN+1a, GateN+1b, GateN+2a, GateN+2b, GateN+3a, and GateN+3b), the first selection signal MUX1, the second selection signal MUX2, and the plurality of source line terminals S1 to S6 will be mainly described.

When the first transfer signal TRNm is set to the high level, the first enable signal EN1 is set to the high level, and the first selection signal MUX1 is set to the high level, the gate line GateNa is set to the high level. Here, gradation signals P11, P12, P13, P14, P15, and P16 are supplied from the source line terminals S1 to S6 to the signal lines Sg1, Sg2, Sg3, Sg4, Sg5, and Sg6, respectively, and the corresponding gradation signals are written to the six pixels of the corresponding first row.

Next, when the first transfer signal TRNm is set to the high level, the first enable signal EN1 is set to the high level, and the second selection signal MUX2 is set to the high level, the gate line GateNb is set to the high level. Here, gradation signals P21, P22, P23, P24, P25, and P26 are supplied from the source line terminals S1 to S6 to the signal lines Sg1, Sg2, Sg3, Sg4, Sg5, and Sg6, respectively, and the corresponding gradation signals are written to the six pixels of the corresponding second row.

Next, when the first transfer signal TRNm is set to the high level, the second enable signal EN2 is set to the high level, and the first selection signal MUX1 is set to the high level, the gate line GateN+1a is set to the high level. Here, gradation signals P31, P32, P33, P34, P35, and P36 are supplied from the source line terminals S1 to S6 to the signal lines Sg1, Sg2, Sg3, Sg4, Sg5, and Sg6, respectively, and the corresponding gradation signals are written to the six pixels of the corresponding third row.

Next, when the first transfer signal TRNm is set to the high level, the second enable signal EN2 is set to the high level, and the second selection signal MUX2 is set to the high level, the gate line GateN+1b is set to the high level. Here, gradation signals P41, P42, P43, P44, P45, and P46 are supplied from the source line terminals S1 to S6 to the signal lines Sg1, Sg2, Sg3, Sg4, Sg5, and Sg6, respectively, and the corresponding gradation signals are written to the six pixels of the corresponding fourth row.

Next, when the second transfer signal TRNm+1 is set to the high level, the first enable signal EN1 is set to the high level, and the first selection signal MUX1 is set to the high level, the gate line GateN+2a is set to the high level. Here, gradation signals P51, P52, P53, P54, P55, and P56 are supplied from the source line terminals S1 to S6 to the signal lines Sg1, Sg2, Sg3, Sg4, Sg5, and Sg6, respectively, and the corresponding gradation signals are written to the six pixels of the corresponding fifth row.

Next, when the second transfer signal TRNm+1 is set to the high level, the first enable signal EN1 is set to the high level, and the second selection signal MUX2 is set to the high level, the gate line GateN+2b is set to the high level. Here, gradation signals P61, P62, P63, P64, P65, and P66 are supplied from the source line terminals S1 to S6 to the signal lines Sg1, Sg2, Sg3, Sg4, Sg5, and Sg6, respectively, and the corresponding gradation signals are written to the six pixels of the corresponding sixth row.

Next, when the second transfer signal TRNm+1 is set to the high level, the second enable signal EN2 is set to the high level, and the first selection signal MUX1 is set to the high level, the gate line GateN+3a is set to the high level. Here, gradation signals P71, P72, P73, P74, P75, and P76 are supplied from the source line terminals S1 to S6 to the signal lines Sg1, Sg2, Sg3, Sg4, Sg5, and Sg6, respectively, and the corresponding gradation signals are written to the six pixels of the corresponding seventh row.

Next, when the second transfer signal TRNm+1 is set to the high level, the second enable signal EN2 is set to the high level, and the second selection signal MUX2 is set to the high level, the gate line GateN+3b is set to the high level. Here, gradation signals P81, P82, P83, P84, P85, and P86 are supplied from the source line terminals S1 to S6 to the signal lines Sg1, Sg2, Sg3, Sg4, Sg5, and Sg6, respectively, and the corresponding gradation signals are written to the six pixels of the corresponding eighth row.

Next, parasitic elements between the source terminals and the signal lines of the display device will be described by using FIG. 10. FIG. 10 depicts a parasitic resistance element and a parasitic capacitive element as parasitic elements between the source terminals (S1 and the like) and the signal lines (Sig: Sg1, Sg2, Sg3, Sg4, Sg5, and Sg6). As depicted in FIG. 10, the following parasitic elements exist between the source terminal S1 and the signal line Sig.

1) A parasitic resistance element Ric of wiring connected to the source terminal S1 in the source line driver 100

2) A parasitic resistance element Rv and a parasitic capacitive element Cs based on a video line and routing wiring thereof

3) A parasitic resistance element Rsig and a parasitic capacitive element Csig of the signal line Sig

Since the multiplexer 110 is not provided between the source terminal S1 and signal line Sig, the parasitic resistance element and the parasitic capacitive element of the multiplexer 110 are eliminated.

Thus, the followings are conceivable in the display device 10c of FIG. 8.

(1) The aperture ratio and the optical characteristics are improved as compared with the display devices 10a and 10b because one signal line and one gate line are provided for each pixel. Black matrix layers for shielding light are preferably provided above arrangement portions of the plurality of gate lines (GateNa, GateNb, GateN+1a, GateN+1b, GateN+2a, GateN+2b, GateN+3a, and GateN+3b) in FIG. 7.

(2) The number of pixels is the same as the display devices 10a and 10b, and can be 1.5 times in the first direction X and twice in the second direction as compared with the display device 10r in FIG. 1.

(3) Since the time constant between the video line and the signal line Sig is improved as compared with the display devices 10a and 10b, it is possible to complete writing of a signal to each pixel within a specified time.

It should be noted that two signals of the first enable signal EN1 and the second enable signal EN2 have been described as examples in FIG. 8 and FIG. 9, but the present invention is not limited thereto. For example, the cycle of the transfer clock CKV can be set to be twice that depicted in FIG. 9, and the enable signal can be configured with four signals. In addition, it is possible to employ a configuration in which the cycle of the transfer clock CKV is set to be 1/2 of that depicted in FIG. 9 and the enable signals are not employed.

The display device 10c of the second embodiment can be summarized as follows.

The display device 10c includes: a plurality of pixels (PIX: P11 to P86) arranged in a matrix shape in a row direction (first direction X) and a column direction (second direction Y); a plurality of gate lines (GateNa, GateNb to GateN+3a, and GateN+3b) connected to the pixels arranged in the row direction such that each pixel arranged in one row direction is connected to one gate line in the plurality of pixels PIX; a plurality of signal lines (Sg1 to Sg6) connected to the pixels arranged in the column direction such that each pixel arranged in one column direction is connected to one signal line in the plurality of pixels PIX; a gate line driving circuit GDC2 for scanning the plurality of gate lines (GateNa, GateNb to GateN+3a, and GateN+3b); and a signal line driving circuit for supplying gradation signals to the plurality of signal lines (Sg1 to Sg6).

The gate line driving circuit GDC2 includes a first selection signal MUX1 for selecting one (GateNa, GateN+1a, GateN+2a, GateN+3a) of two adjacent gate lines ((GateNa and GateNb), (GateN+1a and GateN+1b), (GateN+2a and GateN+2b), (GateN+3a and GateN+3b)), and a second selection signal MUX2 for selecting the other (GateNb, GateN+1b, GateN+2b, GateN+3b) of the two adjacent gate lines.

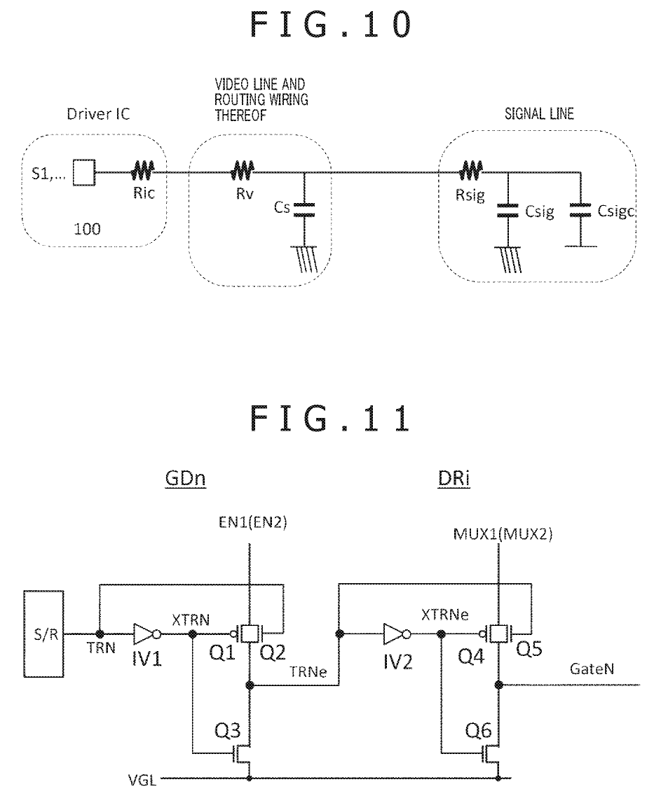

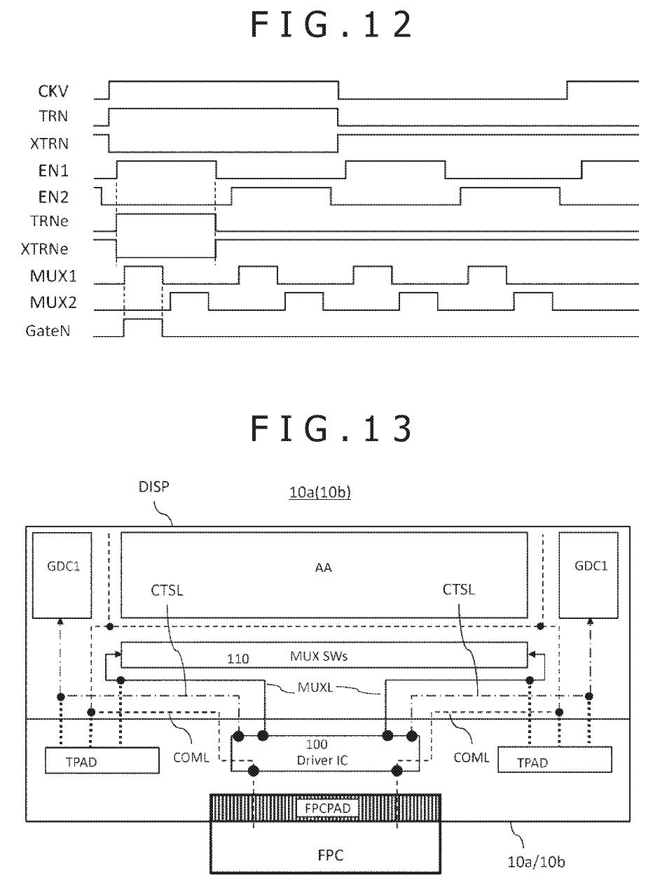

Next, a configuration example of the gate driver selection circuits (GD1 to GD4) and the gate driving circuits (DR1 to DR8) will be described by using FIG. 11. FIG. 11 is a diagram for depicting a configuration example of the gate driver selection circuit and the gate driving circuit. FIG. 12 is a diagram for explaining a timing example of the gate driver selection circuit and the gate driving circuit.

As depicted in FIG. 11, a gate driver selection circuit GDn includes an inverter circuit IV1 and transistors Q1, Q2, and Q3. The input terminal of the inverter circuit IV1 is connected to the output terminal of a shift register S/R, and is configured to receive a transfer signal TRN from the shift register S/R. The output terminal of the inverter circuit IV1 is connected to the gate electrode of the P-channel type (first conductive type) transistor Q1, and is configured to receive an inversion signal XTRN of the transfer signal TRN from the inverter circuit IV1.

The source electrode of the transistor Q1 is configured to receive the enable signal EN1 (or EN2), and the drain electrode of the transistor Q1 is connected to the drain electrode of the N-channel type (second conductive type) transistor Q3. The gate electrode of the transistor Q3 is connected to the gate electrode of the transistor Q1, and the source electrode of the transistor Q3 is connected to a ground potential line VGL to which a ground potential is supplied. The transistor Q1 and the transistor Q3 configure an inverter circuit. In addition, the source-drain path of the N-channel type (second conductive type) transistor Q2 is provided in parallel with the source-drain path of the transistor Q1 to configure a CMOS switch. The gate electrode of the transistor Q2 is connected to the input terminal of the inverter circuit IV1.

A gate driving circuit DRi includes an inverter circuit IV2 and transistors Q4, Q5, and Q6. The input terminal of the inverter circuit IV2 is connected to the drain electrode of the transistor Q1, and is configured to receive a signal TRNe. The output terminal of the inverter circuit IV2 is connected to the gate electrode of the P-channel type (first conductive type) transistor Q4, and is configured to receive an inversion signal XTRNe of the signal TRNe from the inverter circuit IV2.

The source electrode of the transistor Q4 is configured to receive the selection signal MUX1 (or MUX2), and the drain electrode of the transistor Q4 is connected to the drain electrode of the N-channel type (second conductive type) transistor Q6. The gate electrode of the transistor Q6 is connected to the gate electrode of the transistor Q4, and the source electrode of the transistor Q6 is connected to a ground potential line VGL to which a ground potential is supplied. The transistor Q4 and the transistor Q6 configure an inverter circuit. In addition, the source-drain path of the N-channel type (second conductive type) transistor Q5 is provided in parallel with the source-drain path of the transistor Q4 to configure a CMOS switch. The gate electrode of the transistor Q5 is connected to the input terminal of the inverter circuit IV2. The drain electrode of the transistor Q4 is connected to the gate line (GateN).

As depicted in FIG. 12, the gate driver selection circuit GDn and the gate driving circuit DRi selectively set the gate line GateN to the high level (selection level) when the high-level transfer signal TRN is supplied from the shift register S/R, the enable signal EN1 is set to the high level, and the selection signal MUX1 is set to the high level.

As depicted in FIG. 11, in the gate driver selection circuit GDn and the gate driving circuit DRi, all the signals (EN1, EN2, MUX1, and MUX2) are connected to the sources as described above, and thus the load capacity can be reduced as compared with the gate connection. The gate connection of the signals (EN1, EN2, MUX1, and MUX2) is logically possible. In addition, although all the transistors are depicted by single-gate transistors in the above description, it is also possible to employ double-gate transistors.

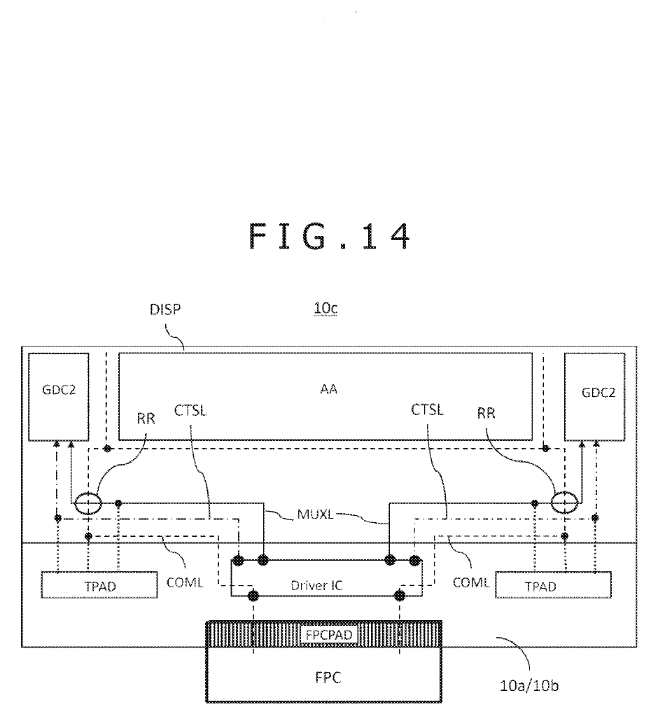

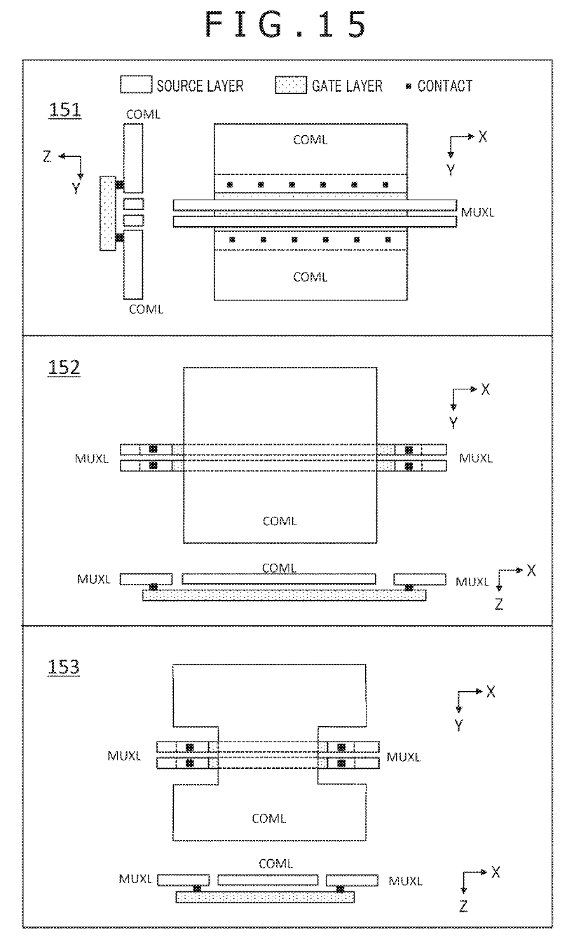

Next, an example of connection between the display device (10a, 10b, or 10c) and a flexible printed circuit board (FPC) will be described. FIG. 13 is a diagram for depicting an example of connection between the display device (10a or 10b) and the flexible printed circuit board (FPC). FIG. 14 is a diagram for depicting an example of connection between the display device (10c) and the flexible printed circuit board (FPC). FIG. 15 is a diagram for depicting a configuration example of an intersection portion between selection signal wiring MUXL and common potential wiring COML in FIG. 14.

FIG. 13 is a diagram for explaining a state where the display device (10a or 10b) has the flexible printed circuit board FPC. The display device (10a or 10b) has a display panel section DISP and a source line driver (Driver IC) 100. The display panel section DISP includes an active region AA, a multiplexer 110, and gate line driving circuits GDC1 divided and arranged on the left and right sides of the active region AA.

In the active region AA, a plurality of pixels PIX, a plurality of gate lines (GateN, GateN+1, GateN+2, and GateN+3), and a plurality of signal lines (Sig) are formed. The common potential wiring COML (depicted by thin dotted lines in FIG. 13) to which a common potential VCOM is supplied is connected to the plurality of pixels PIX. The common potential wiring COML is connected to a part of a plurality of pads FPCPAD provided on the flexible printed circuit board FPC via the source line driver 100.

The multiplexer 110 includes a plurality of first switches SW1 to which a first selection signal MUX1 is supplied and a plurality of second switches SW2 to which a second selection signal MUX2 is supplied. The first selection signal MUX1 and the second selection signal MUX2 are supplied to the multiplexer 110 from the source line driver 100 via first signal wiring MUXL (depicted by thin solid lines in FIG. 13) formed on the flexible printed circuit board FPC. The first signal wiring MUXL can be rephrased as selection signal wiring MUXL, and the selection signal wiring MUXL includes selection signal wiring for the first selection signal MUX1 and selection signal wiring for the second selection signal MUX2.

The gate line driving circuit GDC1 includes the first shift register S/R, the second shift register S/R, and the plurality of the gate drivers GD1 to GD4 of the display device (10a or 10b). The control signals (STV, CKV, EN1, and EN2) supplied from the source line driver 100 are supplied to the gate line driving circuit GDC1 from the source line driver 100 via second signal wiring CTSL (depicted by thin dashed lines in FIG. 13) formed on the flexible printed circuit board FPC.

Although there is a different case depending on the arrangement specification of signal pins of the source line driver 100, the first signal wiring MUXL and the common potential wiring COML are basically connected to each section of the display panel section DISP without crossing each other. Therefore, since the wiring of the first signal wiring MUXL and the common potential wiring COML can be always formed of a low-resistance material (for example, a source layer on which the signal lines Sig are formed), the resistance value can be made smaller.

It should be noted that in the case of arranging inspection pads TPAD, the first signal wiring MUXL and the common potential wiring COML cross (intersect) connection wiring (thick broken lines) to the inspection pads TPAD, but the first signal wiring MUXL and the common potential wiring COML do not cross each other, which causes no problem.

In portions where the first signal wiring MUXL and the common potential wiring COML cross the connection wiring (thick broken lines) to the inspection pads TPAD, the connection wiring can be a gate layer on which a plurality of gate lines are formed.

FIG. 14 is a diagram for explaining a state where the display device 10c has the flexible printed circuit board FPC. The display device 10c has a display panel section DISP and a source line driver (Driver IC) 100. The display panel section DISP includes an active region AA and gate line driving circuits GDC2 divided and arranged on the left and right sides of the active region AA. Each of the gate line driving circuits GDC2 includes the first shift register S/R, the second shift register S/R, the plurality of gate drivers GD1 to GD4, and the gate driving circuits DR1 to DR8 of the display device 10c.

FIG. 14 is different from FIG. 13 in that the multiplexer 110 is eliminated, the first signal wiring MUXL is supplied to the gate line driving circuits GDC2, and the first signal wiring MUXL and the common potential wiring COML intersect (cross) each other at intersection portions RR indicated by thick circles.

Therefore, it is necessary to devise a wiring method at the intersection portions RR between the first signal wiring MUXL and the common potential wiring COML. That is, since the first signal wiring MUXL and the common potential wiring COML cross each other at least at one point, it is necessary to change the connection of either the first signal wiring MUXL or the common potential wiring COML to the wiring layer of a layer (gate layer) different from the wiring layer of the source layer.

FIG. 15 depicts three configuration examples of the intersection portions between the first signal wiring MUXL and the common potential wiring COML in FIG. 14. As a prerequisite, the first signal wiring MUXL extends along the first direction X and is mainly formed of the wiring layer of the source layer. It is assumed that the common potential wiring COML extends along the second direction Y and is mainly formed of the wiring layer of the source layer.

A first configuration example 151 is a case in which the first signal wiring MUXL is configured with wiring formed of a low-resistance material (for example, the wiring layer of the source layer on which the signal lines Sig are formed) and the resistance value is made smaller. This configuration is assumed to be a wiring structure in which priority is given to the first signal wiring MUXL. At the intersection portions between the first signal wiring MUXL and the common potential wiring COML, the common potential wiring COML is formed under the first signal wiring MUXL in the third direction Z by using the wiring layer of a short and wide gate layer, and is allowed to intersect the first signal wiring MUXL.

A second configuration example 152 is a case in which the common potential wiring COML is configured with wiring formed of a low-resistance material (for example, the wiring layer of the source layer on which the signal lines Sig are formed) and the resistance value is made smaller. This configuration is assumed to be a wiring structure in which priority is given to the common potential wiring COML. At the intersection portions between the first signal wiring MUXL and the common potential wiring COML, the first signal wiring MUXL is formed under the common potential wiring COML in the third direction Z by using the wiring layer of a long and thin gate layer, and is allowed to intersect the common potential wiring COML.

That is, in the first configuration example 151 and the second configuration example 152, at the intersection portions between the common potential wiring COML and the selection signal wiring MUXL, one of the common potential wiring COML and the selection signal wiring MUXL is formed on the wiring layer different from the other of the common potential wiring COML and the selection signal wiring MUXL.

A third configuration example 153 is a modified example of the second configuration example 152, and the length of the first signal wiring MUXL formed of the wiring layer of the gate layer that is wired under the common potential wiring COML is made as short as possible to reduce an increase in the wiring resistance of the first signal wiring MUXL. On the other hand, the width of the common potential wiring COML positioned above the first signal wiring MUXL formed of the wiring layer of the gate layer is locally shortened to reduce an increase in the wiring resistance of the common potential wiring COML.

All display devices that can be carried out by a person skilled in the art by appropriately changing the design on the basis of the display devices described as the embodiments of the present disclosure also belong to the scope of the present disclosure as long as they include the gist of the present disclosure.

Within the meaning of the idea of the present disclosure, it is understood that a person skilled in the art can arrive at various change examples and correction examples, and these change examples and correction examples also belong to the scope of the present disclosure. For example, modes obtained by appropriately adding or deleting a constitutional element to/from each embodiment described above, or changing the design thereof, or by adding or omitting a process to/from each embodiment described above, or changing the conditions thereof by a person skilled in the art are included in the scope of the present disclosure as long as the gist of the present disclosure is provided.

In addition, it is understood that other working effects obtained by the modes described in the present embodiments that are apparent from the description of the present specification or that a person skilled in the art can appropriately arrive at are naturally obtained by the present invention.

Various inventions can be formed by appropriate combinations of the plurality of constitutional elements disclosed in the above-described embodiments. For example, some constitutional elements may be deleted from all the constitutional elements depicted in the embodiments. Further, constitutional elements in different embodiments may be appropriately combined with each other.

What is claimed is:

1. A display device comprising:
a plurality of pixels arranged in a matrix shape;
a plurality of gate lines connected to the pixels arranged in a row direction;
a plurality of signal lines connected to the pixels arranged in a column direction;
a gate line driving circuit for scanning the plurality of gate lines; and
a signal line driving circuit for supplying gradation signals to the plurality of signal lines, wherein
the pixels arranged in the column direction include a plurality of first pixels connected to a first signal line and a plurality of second pixels connected to a second signal line, and
the first signal line and the second signal line are provided in parallel with the pixels arranged in the column direction.

2. The display device according to claim 1, wherein,
when the gate line driving circuit selects one gate line, the signal line driving circuit writes corresponding gradation signals from the first signal line to the plurality of first pixels, and then writes corresponding gradation signals from the second signal line to the plurality of second pixels.

3. The display device according to claim 1, wherein
the plurality of first pixels and the plurality of second pixels are alternately arranged in the column direction.

4. The display device according to claim 2, wherein
the first signal line and the second signal line are arranged in parallel on one side of the pixels arranged in the column direction.

5. The display device according to claim 2, wherein
the first signal line and the second signal line are arranged in parallel so as to sandwich the pixels arranged in the column direction.

6. The display device according to claim 1, wherein
the plurality of pixels are driven by the gate line driving circuit and the signal line driving circuit on a basis of a field sequential method.

7. A display device comprising:
a plurality of pixels arranged in a matrix shape;
a plurality of gate lines connected to the pixels arranged in a row direction;
a plurality of signal lines connected to the pixels arranged in a column direction;
a gate line driving circuit for scanning the plurality of gate lines; and
a signal line driving circuit for supplying gradation signals to the plurality of signal lines, wherein
the gate line driving circuit includes a first selection signal for selecting one of two adjacent gate lines and a second selection signal for selecting other one of the two adjacent gate lines.

8. The display device according to claim 7, further comprising:
common potential wiring for supplying a common potential to the plurality of pixels; and
selection signal wiring for supplying the first selection signal and the second selection signal from the signal line driving circuit to the gate line driving circuit, wherein
at a portion where the common potential wiring and the selection signal wiring intersect each other, one of the common potential wiring and the selection signal wiring is formed of a wiring layer different from other one of the common potential wiring and the selection signal wiring, and the common potential wiring and the selection signal wiring interest each other.

9. The display device according to claim 7, wherein
the plurality of pixels are driven by the gate line driving circuit and the signal line driving circuit on a basis of a field sequential method.
